(19) United States
(12) Patent Application Publication
(10) Pub. No.: US 2022/0103369 A1
(43) Pub. Date: Mar. 31, 2022

(54) SECURITY SYSTEM AND RELATED METHODS

(71) Applicant: ETHOPASS, LLC, Boulder, CO (US)

(72) Inventors: Joshua Freeman Adams, Boulder, CO (US); David Patrick Forster, Miami, FL (US); Frank Barry Robertson, Jacksonville, FL (US)

(21) Appl. No.: 17/426,719

(22) PCT Filed: Feb. 3, 2020
(86) PCT No.: PCT/US2020/016347

§ 371 Date: Jul. 29, 2021

Related U.S. Application Data
(60) Provisional application No. 62/801,148, filed on Feb. 5, 2019.
(60) Provisional application No. 62/807,832, filed on Feb. 20, 2019.

(51) Int. Cl. H04L 9/32; H04L 9/06; H04L 9/08; H04L 9/30

(52) U.S. Cl. CPC H04L 9/3242; H04L 9/0643; H04L 2209/38; H04L 9/3073; H04L 9/0894; H04L 9/0869

(57) ABSTRACT

A method includes entropy hashing a hardened key; generating an asymmetric key pair from the hardened key; generating a keyspace chaincode from the hardened asymmetric key pair and the hardened key; and generating a verification key pair from the hardened asymmetric key pair. Related systems and methods are disclosed herein.

### CROSS-REFERENCE TO RELATED APPLICATIONS

This application is a 35 U.S.C. 371 national stage entry of, and claims priority to, PCT/US20/16347 filed Feb. 3, 2020 and entitled SECURITY SYSTEM AND RELATED METHODS, which claims priority to U.S. Provisional Application No. 62/801,148 filed Feb. 5, 2019 and entitled SECURITY SYSTEM AND RELATED METHODS, and to U.S. Provisional Application No. 62/807,832 filed Feb. 20, 2019 and entitled SECURITY SYSTEM AND RELATED METHODS. The entire disclosures of the above-referenced applications are hereby incorporated by reference for all proper purposes.

### FIELD OF THE INVENTION

This invention is related to systems and methods for authenticating a user.

### BACKGROUND OF THE INVENTION

A number of methods of authenticating a user are available. There remains a need, however, for a more secure system.

### SUMMARY OF THE INVENTION

An exemplary method includes entropy hashing a hardened key; generating an asymmetric key pair from the hardened key; generating a keyspace chaincode from the hardened asymmetric key pair and the hardened key; and generating a verification key pair from the hardened asymmetric key pair.

An exemplary tangible, computer-readable medium has instructions which, when executed, carry out a method. The method includes entropy hashing a hardened key; generating an asymmetric key pair from the hardened key; generating a keyspace chaincode from the hardened asymmetric key pair and the hardened key; and generating a verification key pair from the hardened asymmetric key pair.

An exemplary method of generating a recovery key includes entropy hashing a hardened key; generating an asymmetric key pair from the hardened key; generating a keyspace chaincode from the hardened asymmetric key pair and the hardened key; computing a non-collidable pseudo-random value; and passing the pseudo-random value to the keyspace chaincode to generate the recovery key.

An exemplary tangible, computer-readable medium has instructions which, when executed, carry out a method of generating a recovery key. The method includes entropy hashing a hardened key; generating an asymmetric key pair from the hardened key; generating a keyspace chaincode from the hardened asymmetric key pair and the hardened key; computing a non-collidable pseudo-random value; and passing the pseudo-random value to the keyspace chaincode to generate the recovery key.

An exemplary method includes providing an asymmetric key pair having a public key and a private key from an elliptic curve; signing the public key with a first message authentication code; sending the public key and the first message authentication code to another party; receiving a first encrypted data package and a second message authentication code from the another party; using the private key, decrypting the first encrypted data package; receiving a symmetric encryption key and a nonce from the another party; sending a second encrypted data package and a third message authentication code to the another party, wherein the second encrypted data package comprises a public identifier.

An exemplary tangible, computer-readable medium has instructions which, when executed, carry out a method. The method includes providing an asymmetric key pair having a public key and a private key from an elliptic curve; signing the public key with a first message authentication code; sending the public key and the first message authentication code to another party; receiving a first encrypted data package and a second message authentication code from the another party; using the private key, decrypting the first encrypted data package; receiving a symmetric encryption key and a nonce from the another party; sending a second encrypted data package and a third message authentication code to the another party, wherein the second encrypted data package comprises a public identifier.

An exemplary method includes receiving a public key and a first message authentication code from another party; verifying the first message authentication code; using the public key, generating a first encrypted data package having a symmetric encryption key and a first nonce state; adding a second message authentication code to the first encrypted data package; sending the first encrypted data package and the second message authentication code to the another party; receiving a second encrypted data package and a third message authentication code from the another party, wherein the second encrypted data package comprises a public identifier; using a second nonce state and the symmetric encryption key, decrypting the second encrypted data package.

An exemplary tangible, computer-readable medium has instructions which, when executed, carry out a method. The method includes receiving a public key and a first message authentication code from another party; verifying the first message authentication code; using the public key, generating a first encrypted data package having a symmetric encryption key and a first nonce state; adding a second message authentication code to the first encrypted data package; sending the first encrypted data package and the second message authentication code to the another party; receiving a second encrypted data package and a third message authentication code from the another party, wherein the second encrypted data package comprises a public identifier; using a second nonce state and the symmetric encryption key, decrypting the second encrypted data package.

An exemplary method of services identification includes providing asymmetric key pair storage for services identification, having a public key stored on a service using a private key to authenticate against.

An exemplary tangible, computer-readable medium has instructions which, when executed, carry out a method of services identification. The method includes providing asymmetric key pair storage for services identification, having a public key stored on a service using a private key to authenticate against.

An exemplary web-based service includes an asymmetric key pair storage for services identification, having a public key stored on the service and using a private key to authenticate against.

A tangible, computer-readable medium comprising instructions which, when executed, carry out a method of web-based service, comprising authenticating a public key stored on the service against a private key.

### BRIEF DESCRIPTION ON THE DRAWINGS

FIG. 1 is a table illustrating UDP message format protocol;

FIG. 2 is a protocol table;

FIG. 3 is a table illustrating error protocols;

FIG. 4 is a table illustrating a state transition protocol;

FIG. 5 is a table with a requestor state transition protocol;

FIG. 6 is a table with a gLFSR Key Protocol;

FIG. 7 is table illustrating a Galois Nonce Generation Linear Feedback Shift Register;

FIG. 8 is a table illustrating a return package compilation;

FIG. 9 is a related Protocol Table;

FIG. 10 is a table illustrating a Server and Client State Transition;

FIG. 11 is a Maximal gLFSR Table;

FIG. 12 is a State & Protocol Table;

FIG. 13 is table illustrating a Responder, Requestor, and Client State Transition;

FIG. 14 is a table illustrating an exemplary Token Serialization 1;

FIG. 15 is a table illustrating an exemplary Token Serialization 2;

FIG. 16 is for a diagram illustrating details of a passport as described herein;

FIG. 17 is a diagram illustrating Authentication & Authorization methods;

FIG. 18 is a diagram illustrating details of passphrase+seedphrase;

FIG. 19 is a diagram illustrating a Token Service: Recovery and Database Architecture;

FIG. 20 is diagram illustrating an exemplary system;

FIG. 21 is a flowchart of an exemplary method;

FIG. 22 is a flowchart of an exemplary method;

FIG. 23 is a flowchart of an exemplary method;

FIG. 24 is a flowchart of an exemplary method;

FIG. 25 is a flowchart of an exemplary method; and

FIG. 26 is a diagram of an exemplary system.

### DETAILED DESCRIPTION

Embodiments described herein are related to authenticating a user on a distributed authentication system. Embodiments described herein may include a user authentication system and/or method, such as, for example, a process of authenticating a user on a distributed authentication protocol system with a passport. Embodiments described herein may be designed to achieve a high level of reliability, performance, responsiveness, scalability, capacity, and/or security.

Some embodiments may include an Oracle model authentication architecture. The Oracle protocol may include methods dictating how the authentication system negotiates transactional passport authentication/authorization interactions to verify users or remote systems.

Some embodiments may include a peer-to-peer distributed authentication architecture or protocol. The peer-to-peer authentication protocol may include a localized “test,” that if completed by the correct authorized passport, a valid session is returned, and a secure connection to a frontend client is negotiated. The session state may be held within a counter module (defined in other sections herein). At any point, if the endpoint is served, the current “ping-pong,” state may be disrupted and a new session may be validated.

Some embodiments may include a passport, or distributed communication and interaction functionality architecture or protocol. The passport may be equivalent to a cryptocurrency wallet that allows the storage of private and public keys, enabling users to receive digital tokens. The passport may be used to store tokens associated with a user's account(s), which may allow the user to authorize the user against any application storing the corresponding public key.

Some embodiments may include a token service, or recovery and databasing method(s) architecture variants run by the service provider and installed locally. The token service may store up to 18 quintillion tokens and public keys for users to be distributed as needed to provide access to their service. The token service may provide an ability to store immutable records, and setup the recovery process. The token service may provide a method in which a company can write to a byzantine fault tolerant network or blockchain.

Before providing a detailed description of embodiments herein, certain definitions are provided for the purpose of this disclosure, unless otherwise stated:

A connectionless system is used herein to reference instances in which messages are sent independently of each other.

In a system, a communication model is a low-level event-driven system.

In a system, a distributed computing model is a system in which both or multiple components are equivalent, or on a peer-to-peer system.

The term middleware is generally understood as a system used to initiate processes at different computing systems. Middleware may handle session management, act as a directory service to allow clients to locate servers, and/or provide remote data access protocol. Middleware may provide concurrency control to allow servers to handle multiple clients, maintain security and/or integrity of a connection, and/or monitor for any foul play on the network. Middleware may terminate local and/or remote processes if required.

Points of failure may occur where the network contention causes a timeout(s), a system has poor connectivity, and/or there is a conflicting network address. Points of failure may also occur when transmission errors cause lost messages, the client and server versions are incompatible, and/or the server's database is corrupted. Points of failure may also include instances in which the client side of an application crashes.

Public key cryptography includes any cryptographic system that uses pairs of keys: public keys which may be disseminated widely, and private keys which are known only to the owner. This accomplishes two functions: authentication, where the public key verifies that a holder of the paired private key sent the message, and encryption, where only the paired private key holder can decrypt the message encrypted with the public key.

Galois Linear Feedback Shift Register (gLFSR) is a configuration, which is also known as modular, internal XORs as well as one-to-many LFSR, is an alternate structure that can generate the same output stream as a conventional LFSR. In the Galois configuration, when the system is clocked, bits that are not taps are shifted one position to the right unchanged. The taps, on the other hand, are XOR'd with the output bit before they are stored in the next position. The new output bit is the next input bit. The effect of this is that when the output bit is zero all the bits in the register shift to the right unchanged, and the input bit becomes zero. When the output bit is one, the bits in the tap positions all flip (if they are 0, they become 1, and if they are 1, they become 0), and then the entire register is shifted to the right and the input bit becomes 1.

A cryptographically secure pseudorandom number generator uses entropy obtained from a high-quality source, generally the operating system's randomness to generate a secure random number. However, unexpected correlations have been found in several such ostensibly independent processes. From an information-theoretic point of view, the amount of randomness, the entropy that can be generated, is equal to the entropy provided by the system. There are three primary factors that determine “randomness.” 1) It appears random 2) Its value is unpredictable in advance 3) it cannot reliably be reproduced after generation. The assumption is to use the systems PRNG as a ‘SecureRandom/dev/urandom’ process by the native system.

A Content Encryption Key (CEK) is a public-key signature system for fast single-signature verification.

An AEAD algorithm is one that encrypts the plaintext, allows additional authenticated data to be specified, and provides an integrated content integrity check over the ciphertext and additional authenticated data. AEAD algorithms typically accept two inputs, the plaintext and the Additional Authenticated Data value, and produce two outputs, the ciphertext and the authentication tag value.

An Authentication Tag (aT) is an output of an AEAD operation that ensures the integrity of the ciphertext and the additional authenticated data.

An Encrypted Key (EK) is an encrypted content encryption key value

A Key Encryption(kE) is a Key Management Mode in which the CEK value is encrypted to the intended recipient using an asymmetric encryption algorithm.

An Initialization Vector (IV) is an initialization vector value used when encrypting plaintext values.

Ciphertext (cT) value is the resulting data from authenticated encryption of the plaintext with additional authenticated data.

Compact Serialization (cS) is a compact protobuf web token encoding format.

Key Wrapping (kW) is a Key Management Mode in which the CEK value is encrypted to the intended recipient using a symmetric key wrapping algorithm.

Direct Encryption (dE) is a Key Management Mode in which the CEK value used is the secret symmetric key value shared between the parties.

Returning now to the Oracle model authentication architecture previously referenced, further details are described herein. Protocol Design may include the following features: 1) UDP broadcast, not point-to-point until after the successful DHKE with target; 2) Duel transaction state managed by passport, and auth service; 3) Transport protocol is reliable; 4) Lost replies, or reply timeouts, should trigger a rebuild of all cryptographic packages (message packets are never reused); 5) Byte encoding data format; 6) Communications are bursty and must be managed by Quality of Service definitions; 7) Data synchronization is required only after successful authorization negotiation; 8) Application agnostic communication protocol.

Version Control: The protocol in the distributed system may evolve over time as the system expands. This raises compatibility issues over time, which should be addressed here-in. Each side should ideally be able to understand messages for its own version and all earlier ones. It should be able to write replies to old style queries in old style response format.

Protocol Stages

1. In(msg): a. Desc: Ping auth service, and request DHKE for initial exchange of TxHash. b. Error: Verify TxHash.

2. Enc(msg): a. Desc: Negotiate transfer of symmetric encryption keys. b. Error: Verify indv msg.

3. Ver(msg): a. Desc: Verify Enc(msg) and return. b. Error: Verify correct recipient.

In(msg): Pseudo-Diffie-Hellman Key Echange, TxHash Identification. Initial assumptions are: 1. Responder(Auth API) has the (TxHash, Public Key) for Requestor(passport) stored. 2. Requestor(passport) has the correlated Private Key, for stored Public Key.

See FIG. 1 illustrating an exemplary UDP message format 100.

Data Format: The server computes random large prime number (nonce) passed to an elliptic curve algorithm and stores output public/private key until successful return of encrypted TxHash to locate target public key. The generated public key is returned to the requestor to encrypt the target TxHash. Msg=select (g) public/private key generator. Pub->32 bytes. Pvt->32 bytes. TxHash->˜32 bytes.

The State is managed by both the Requestor(passport), and Responder(Auth API). At any point, if the connection is lost before a viable TxHash is received by the Responder, the state is reset to initial response msg and regardless of transaction success, the nonce, and generated public/private keys are reset, and regenerated. The nonce and generated public/private keys are never to be used twice.

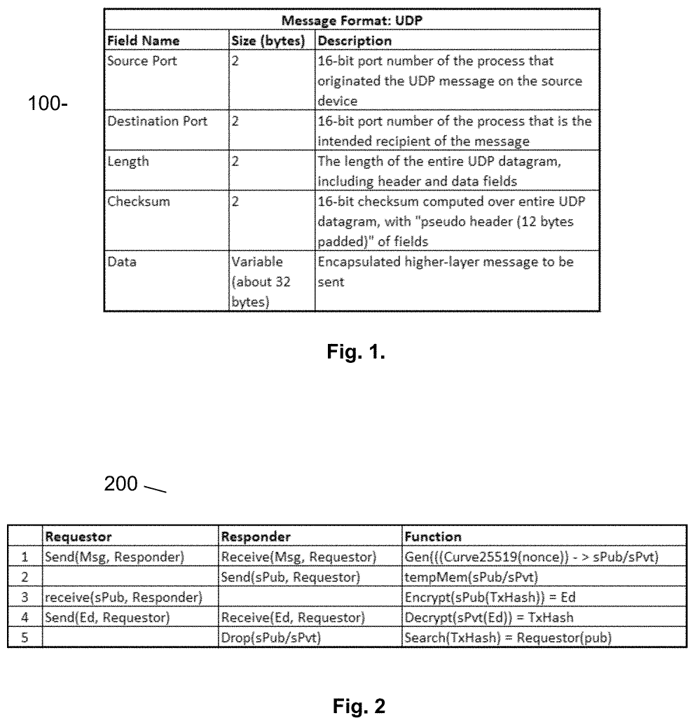

See FIG. 2 illustrating an exemplary protocol table 200, which may be relied upon in embodiments herein.

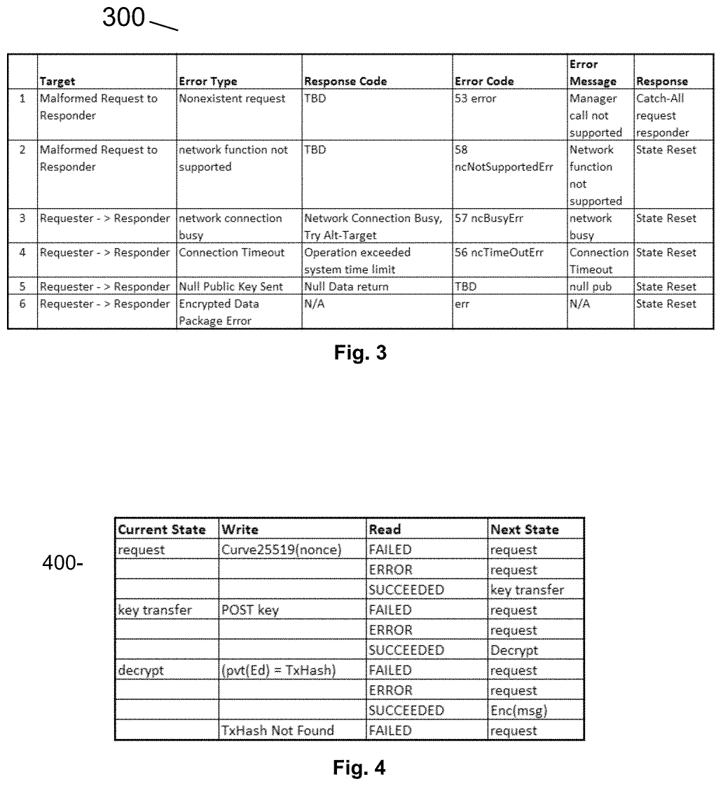

Error. During this initial phase, if a valid TxHash hasn't been received by the Responder(Auth API), then the state is reset, and the transaction starts anew, to protect against any possible replay attacks. As state is managed in duality, any error response should reset the state on both sides (Requestor, Responder). Actual error response codes will be null or repackaged with honey encryption (supply fake data with authentic appearance). See FIG. 3 illustrating an exemplary table of errors 30, which may be relied upon in embodiments herein.

See FIG. 4 illustrating an exemplary table with a responder state transition protocol 400, which may be relied upon in embodiments herein. Responder(Auth API) State Transition Diagram: In(msg)->Enc(msg).

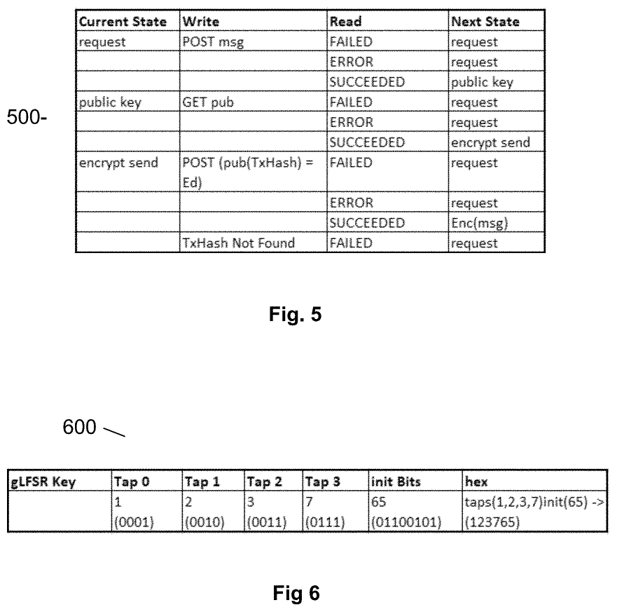

See FIG. 5 illustrating an exemplary table with a requestor state transition protocol 500, which may be relied upon in embodiments herein. Requestor(passport) State Transition Diagram: In(msg)->Enc(msg).

Enc(msg): Symmetric encryption cypher exchange, hash message decryption verification. Once In(msg) is complete, Enc(msg) becomes the next fallback point, given that a valid TxHash was found during In(msg) protocol, and the original IP/Port requestor hasn't changed.

Nonce Generation. Using a randomly generated 8-bit collection, the gLFSR is then implemented to generate the next nonce in the sequence. The rolling nonce counter is incremented for each state change. The symmetric encryption algorithm utilizes a randomly generated key and nonce to encrypt and decrypt incoming/outgoing cyphers. Once 12 bytes of the shift register can be hex encoded, the Hex string is converted into a byte array and passed as the nonce, giving the (next) number in the sequence.

Serialization Format. In order to generate the correct shift, a 7 byte collection will be encrypted, and prepended to the symmetric encryption algorithm key (32 bytes). 4 byte: version bytes (0x01). 1 byte: pad (x). 7 byte: gLFSR key. 2 byte: pad (0x). 32 byte: symmetric encryption key.

See FIG. 6 illustrating an exemplary gLFSR Key Protocol 600, which may be relied upon in embodiments described herein.

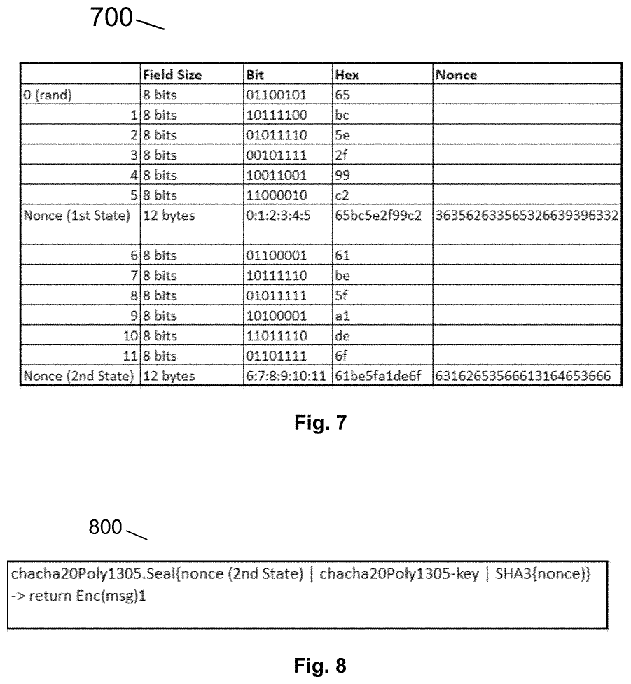

See FIG. 7 illustrating an exemplary Galois Nonce Generation Linear Feedback Shift Register 700, which may be relied upon in embodiments herein.

Data Format. Responder generates a new gLFSR key, symmetric encryption algorithm key, and random nonce hash. Then, using the Requestors public key, the 80 byte Enc(msg)0 package is encrypted and sent to the requestor for private key verification. Once the requestor receives the Enc(msg)0 package, the information is decrypted with the applicable private key. Then a return package is compiled using a symmetric encryption algorithm. See FIG. 8 illustrating an exemplary return package compilation 800, which may be relied upon in embodiments disclosed herein.

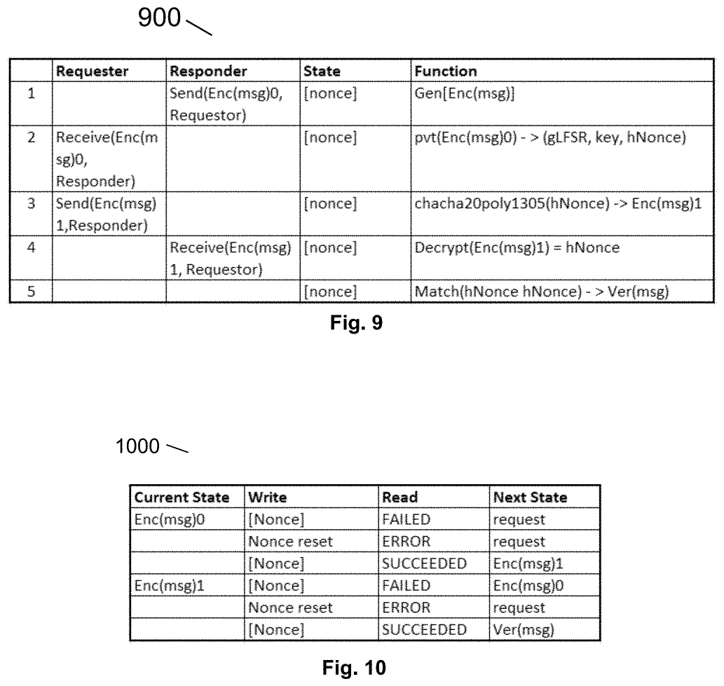

See FIG. 9 illustrating an exemplary related Protocol Table 900, which may be relied upon in embodiments disclosed herein.

Error. At any point, if any package is unable to be decrypted, an error return will be sent to the requestor and responder. All keys, nonces, and applicable generated data is reset, and the connection is terminated.

If Enc(msg)0 is <∥>80 bytes, and error message is generated by the requestor, and state is reset, and the connection is terminated. Reset to initial request state and broadcast new request.

If the returned hashed nonce doesn't match the original generated hashed nonce, a critical error is generated, and related traffic needs to be logged for further inspection. Connection is terminated.

If at any point a package/message is resent or duplicated to the responder or requestor, an error is generated, and the connection is terminated.

If the connecting IP/Port address(s) are changed, state is reset, and the connection is terminated.

See FIG. 10 illustrating an exemplary table of a Server and Client State Transition Diagram 1000, Enc(msg)->Ver(msg), which may be relied upon in embodiments disclosed herein.

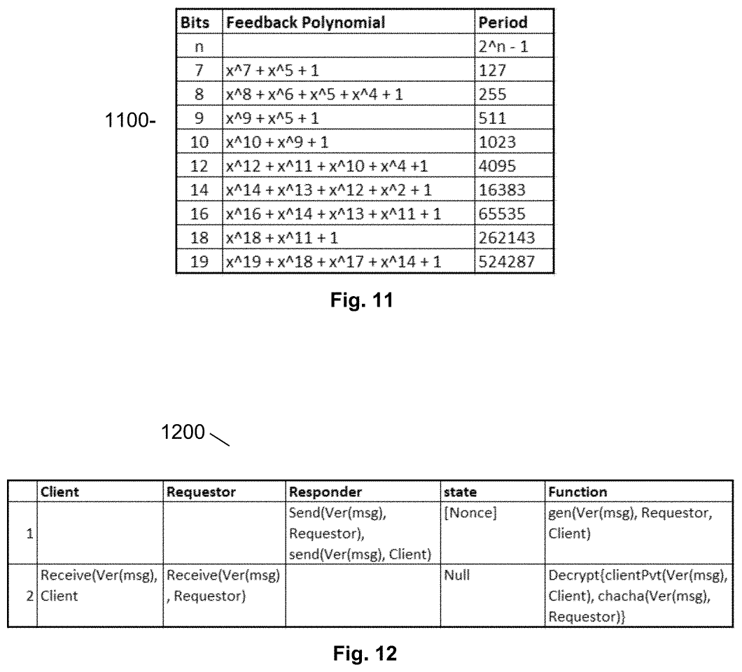

See FIG. 11 illustrating an exemplary Maximal gLFSR Table 1100, which may be relied upon in embodiments disclosed herein.

Ver(msg): Verification of Encrypted Hash, return session token->success.

Assumptions: 1) The requesters private key has been verified. 2) The Responder has the applicable clients public key.

Purpose. The purpose of the Ver(msg) is to generate the returned session id to the applicable requestor, and business server-side session token management. The return package includes a public key, private key, and a cryptographically secure and unique session identifier.

In order for “pre-flight,” encryption to work successfully, two public/private keys are generated by elliptic curve algorithm and the key exchange is handled before send. This is an asymmetric encryption key exchange. The resulting package(s) will contain the decryption key (private key), and the Requesters Public Key. The inverse is completed for the Requestor. (private key, Client public key).

Once the individual packages are ready, the 80 byte package for the requestor is wrapped with symmetric encryption algorithm. The client is then encrypted with the stored environment variable I.E. the clients public key.

Serialization Format. The initialized gLFSR nonce state must be maintained into the Ver(msg), as a symmetric encryption algorithm is the required encryption/decryption protocol post TxHash verification.

Requestor return package: Encryption Package: Symmetric Encryption Algorithm. 16 byte: unique session identifier. 32 byte: public key (pub0). 32 byte: private key (pvt1).

Client return package: Encryption Package: Elliptic Curve Cryptography. 16 byte: unique session identifier. 32 byte: public key (pub1). 32 byte: private key (pvt0).

The client package target is to send to a temporary cache, for server-side session management, and decryption.

See FIG. 12 illustrating an exemplary State & Protocol Table 1200, which may be relied upon in embodiments disclosed herein.

Error: If the Ver(msg) return package is unable to be decrypted by the requestor or client, then an error message is propagated to the affected parties. If a return package is unable to be sent to the requestor, or a package timeout occurs, reset to the previous message state. Enc(msg)->Nonce State 0.

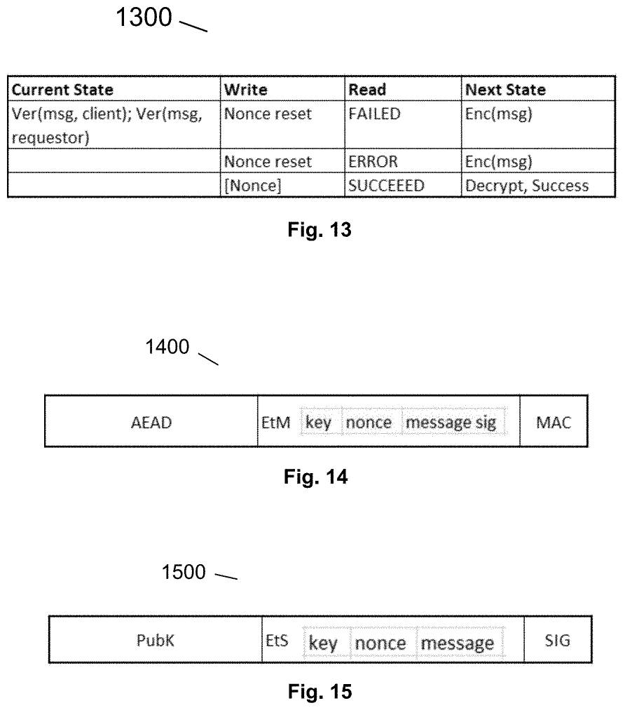

See FIG. 13 illustrating an exemplary Responder, Requestor, and Client State Transition Diagram 1300: Ver(msg)->Complete, which may be relied upon in embodiments disclosed herein.

Middleware Communication model: RPC over UDP or TCP. UDP requires special UDP aware handling due to the nature of UDP sockets. There is no connection, just datagrams sent to an address. For the requestor or responder to get a reply, the respective requestor or responder has to set up a listening socket and then send packets to the other one of the requester or the responder, along with the request. The other one of the requestor or responder would then reply to the aforesaid requestor or responder's address.

V2: Peer-to-peer distributed authentication architecture may include a client, an agent, and a provider. The client is a system or service authenticating or authorizing an agent. An agent is a system, service, or individual requesting access to client services. A provider is a system or service handling setup and verification. In some embodiments, the key authorization protocol represents end-to-end encryption standards to securely authorize and authenticate agents against client infrastructure, without using usernames, passwords, or biometrics. The purpose of this section is to describe the initialization, negotiation, and communication between the client and the agent. The protocol buffers, which may be referenced herein as “protobuf” web token specification, and session authentication object are detailed below. Hierarchical deterministic digital key system capabilities are described in the Passport section of this document. A surface level description of the Passport interaction is also included herein.

The key authorization protocol mechanisms provide the processes that must be completed successfully, in order for an agent to authenticate or authorize against client infrastructure.

Those skilled in the art will recognize that when one needs access to cloud servers, regardless of whether one is logging into an application like Gmail, Linkedin, or Twitter, or downloading historic records from one's online banking platform, usernames and passwords are currently the primary access method. This presents numerous problems not only for organizations but for individuals as well. Organizations have moved to adding additional authentication methods in order to secure individual accounts. These methods include multi-factor authentication, two-factor authentication, two-step authentication, or other similar methods based on the premise that an unauthorized actor is unlikely to be able to supply the factors required for access, and may require that the user be in possession of a physical object, know a secret, have particular biometrics, or be in a particular location.

The problems associated with username and password authentication include but are not limited to: Middle Person Attacks, Encryption Downgrade Attacks, Account recovery process breach (including breaching the primary account holder's email or recovery communication method to recover the individuals account. Replacing the current credentials with credentials chosen by the attacker to authenticate/authorize the attacker), rogue program attacks (webext or webapp attack), Session replay attacks, External entity attacks, Cross-Site scripting (XSS) attacks, SQL injection attacks, Botnet attacks, and/or Credential phishing attacks.

Usernames and passwords have been around since the inception of the internet or digital authentication, with little to no changes in the method of authentication. Additional complexities have been added to the standard username/password combination, making the process of secure authentication a challenge based on the present standards. Another problem is that many or most individuals use the same password for multiple applications, leading to a single point of failure if any of the individual's applications are breached. Then all an attacker has to do, is look for an already breached account, scrape the username (email address usually) and the password hash (encrypted form of a password). When this information is passed to the service to authenticate against, the attacker has a statistically high likelihood of gaining access. In some cases, a plaintext database (a database that is NOT encrypted, and the values can be read by a human) that was leaked provides a particularly weak spot. The problems associated with multi-factor authentication(MFA) include but are not limited to: Nontrivial setup and maintenance for non-technical individual, Over-complication for individual one-off use, a company information breach of the actual identity collection, terminates the benefit of MFA, as the users device(s) are then known. MFA also does not enforce databasing methods, and bad engineering practices lead to massbreaches, MFA or not. Additionally, most systems still rely on an email as the primary recovery method. Finally, assuming an attacker is motivated, this doesn't solve the authentication problem, because adding an additional attack surface doesn't solve the problem. It merely adds an extra step for the motivated attacker. That is, if compromised, the penetrated account has no fallback point, resulting in increased detection metrics as a necessity. If an attacker is able to compromise the secondary device (I.E. cell phone or application), using the cloned version of the device(s), finding the attacker becomes a mere complexity problem, such as P versus NP. Moreover, if an email is used as the fallback method, there is no guarantee that the individual's recovery method wasn't breached first; or was the beach head of the attack.

The key authentication protocol has identified the breaking conditions for standard username/email verification.

Peer-to-Peer Network (P2P): A computer network in which every computer acts as both a client and server, allowing every computer to exchange data and services with every other computer in the network.

Symmetric Encryption Algorithm (SEA): Algorithms for cryptography that use the same cryptographic keys for both encryption of plaintext and decryption of ciphertext. The keys may be identical or there may be a simple transformation to go between the two keys.

Asymmetric Encryption Algorithm (AEA): Public-key cryptography, or asymmetric cryptography, is any cryptographic system that uses pairs of keys: public keys which may be disseminated widely, and private keys which are known only to the owner.

Elliptic Curve Cryptographic (ECC): Elliptic-curve cryptography is an approach to public-key cryptography based on the algebraic structure of elliptic curves over finite fields. ECC requires smaller keys compared to non-ECC cryptography to provide equivalent security.

Cryptographic Hashing Function (CHF): Masks the original data with another value. A hash function can be used to generate a value that can only be decoded by looking up the value from a hash table. The table may be an array, database, or other data structure. A good cryptographic hash function is non-invertible.

Cryptographic Signature (CS): A digital file attached to an electronic document or package that uses encryption and decryption algorithms to verify the document or packages origin and contents.

Cryptographic Nonce: An arbitrary number that can be used only once. Used as a random or pseudo-random number generation in an authentication protocol to ensure that stale messages cannot be reused in replay attacks. They can also be useful as initialization vectors (IV) and in cryptographic hash functions.

Message Authentication Code (MAC): A short piece of information used to authenticate a message. Used to confirm that the message came from the stated sender and has not been changed or altered before the intended recipient received the message.

Version Control: A version control system (VCS) is used to track ongoing changes, and avoid continuous delivery pipeline security risks. As supply chain security risks are rampant and attack methods vary widely. As switching out an application binary at the point-of-contact, can be easier than decrypting or breaking security bearers. The main objective of the version control system is to: track ongoing changes as files are updated, synchronization of deliverables, restoration and backup of previous versions, sandboxing branched changes, package ownership tracking, and merging and branching modifications. Multiple methods of version control may be used. The two primary methods utilized are centralized and decentralized (distributed) version control systems, centralized version control system, and decentralized version control system. The centralized version control system is a version control where the complete package, including its full history are managed by a central server (example: SVN). The decentralized version control system: version control where the complete package, including its full history is mirrored on every system. (example: git)

Where, how, and what is being accessed are tightly controlled factors to ensure and maintain protocol security. In order to ensure validity of all distributed information all individuals accessing any information online are asked to use the original developers access point. Mirrored access points, can contain malicious content. The second verification is to validate the provided signature with the developer's public key for the acquired package. Both the package signature and corresponding public key are necessary for package authentication before install. The key factors to authenticate one has downloaded the correct package are: Cryptographic signature creation date correspond with release version timeline, the packages cryptographic signature was created by the correct respective developer, the provided verification (public) key is the correct corresponding key, cryptographic signature was successfully verified with the public key, decentralized version control systems can have one additional verification step. If there are multiple mirrored access points by design. Multiple source key matching (distributed package consensus) can be completed in order to verify the signature and key provided are correct. This process can also identify any corrupted version control systems. If any of the returned signatures or keys do not match, this can be evidence of source/version tampering to be reported immediately.

Those skilled in the art will recognize that attacks can be executed from a variety of points, and process/verification protection can be provided at various stages or locations. In some embodiments, object download automated verification may be provided. In some embodiments, a distributed package consensus system may be provided.

Some embodiments described herein securely set up, authenticate, and/or authorize agents against client infrastructure. This can be accomplished via server-to-server, individual-to-server, individual-to-individual, or other system means. The goal of the key authentication protocol may be to have the ability to verify the agent without using a username, password, or biometric device. Some embodiments provide an expanding key system with asymmetric encryption keys. The client retains a copy of the agent's public key to authenticate the agent. The intended interaction of the key authentication protocol is to maintain a simplistic interaction; concealing and layering strong encryption protocols by default. Correctly implemented, upon mass data breach of a client hypothetically the databasing methods described below will help reduce individual agents private information from becoming public, reducing the possibility of credential phishing, credential matching from breached sources, and other direct, social, or brute-force attack methods.

The system architecture may include individual components configured in one of many ways, with a commonality being the use of asymmetric encryption keys (public-private keys), generated from a “safe,” elliptic curve, and cryptographically secure nonce, to authenticate individual agents against client infrastructure. In some embodiments, each key is connected to the hierarchical deterministic key system, making the process of recovering every connected account; entering the correct passphrase, and mnemonic phrase. Each individual public-key—client record can be written in one of many ways. The primary concern of the databasing method is that once a record is requested to be written, that the record becomes, or maintains an immutable (unchangeable) state. That if that record were to change, it would and can not be removed. The two records would be instead connected. The databasing methods can range from: a distributed network, such as an InterPlanetary File System, blockchain network (Ex. Ethereum Network) , FTP server storage (Ex. AWS S3) , encrypted table database (Ex. MySQL), encrypted relational database (Ex. Cassandra) , graphical database (Ex. Neo4j) , immutable record text file, and others.

Agent. The agent contains one to two pieces of software. The with the minimum requirement of having a communication medium and a digital passport. If authenticating/authorizing against a browser or web based application; communication with the browser is required. (Web-extension application or other method) The web-extension (or method here) can act as a secure messaging bus. Passing messages from a native based passport application to the browser and/or domain being the intended client infrastructure target. A web-extension can be configured as a fully functioning passport, with the same functionality of a native passport, contained within a browser based (firefox, chrome, opera, safari, ect) application or web-extension. A web-extension based passport is inherently less secure than it native application based passport counterpart. A native application can contain embedded certificates better than a browser, and access securely signed processes; among other security benefits. A native based passport application is a set of core functionality that can be emulated on mobile phones, tablet pads, laptop or desktop computers, servers, iOT or application specific devices, and more.

A passport is what creates, contains, stores, retrieves, and verifies the interaction with different clients. The passport is designed like a hierarchical deterministic cryptocurrency wallet, with new account registration akin to transferring a cryptocurrency token from one party to another. The difference between an actual token transfer with an associated FIAT currency value. The described tokens are merely one of the many storage utility options available to house immutable records. The full description of the passport is provided in the Passport section below. The interaction between a single public-private key pair for an agent to authenticate against one client is described here-in the key auth protocol.

Client. The client is any service or business that provides access to account based (Ex. Reddit.com), personal (Ex. Twitter), private (Ex. Gmail.com) , or secure information infrastructure (Ex. defense.gov), or any system that requires the account owner to verify their identity through a digital medium before a service can be accessed or for access to special features; and/or others. The client needs two pieces of software (in addition to any and all other necessary infrastructure needed to run their specific service) to effectively utilize, and maintain a key based authentication system. The client first must have a defined communication endpoint that is or has the ability to be pre-processed by a deserialization script, and verified before a specific action is taken. Second the client must be able to store encoded public keys, and securely pass individual keys to the token service to create a durable account record. Each key that is stored within the client database, must at minimum contain a public key associated with the account owner, yet may contain: a Transaction Hash (TxHash), 1st public key, 2nd public key, 1st recovery public key, 1st recovery public key, record creation time (year, date, time, second, nanosecond), polymorphic trust rating, array [known_ips], and other individual database fields, which can be used to complete a key authentication handshake with many different methods, and supporting combination data fields to verify specific agents securely. The primary prototype identified defined below.

Provider. The provider deploys and verifies that the interaction between the client systems and the embedded or remote token service is; secure, in working order, and has the necessary fallback, scalability, and recovery methods in place. The provider defines the interaction with the selected immutable databasing method(s), and storage sources. In order to verify the security of record transit methods, and that individual records are accessible to the associated agents passport (I.E. the account owner). It is necessary to verify that the agent, and client have the correct verified method (s) to recover, and locate the record.

The provider can be employees of a client, or another 3rd party service. The provider is only defined during the architecture setup. Once the setup is complete, ongoing maintenance, and functionality monitoring to be maintained by the associated client. The provider can also provide the ongoing maintenance, and monitoring necessary to maintain a secure service.

Protobuf Web Token (pWT).

A web token represents the serialization method for encrypted structured data, packaged for transit utilizing protocol buffers as the defined serialization structure. Protobuf is denoted as the primary serialization method of choice as it is efficient, fast, compact, and cross-platform compatible. Protobuf is only one of the many serialization methods able to compile structured data, passed to an efficient transit method. Many of which would work to serialize, and deserialize necessary authentication/authorization web token data; as long as both the client and agent have the correct corresponding methods. The general function of a pWT is to define the required information to authenticate and authorize an agent against specific clients. A pWT can be configured with more than one defined structure. The base requirement is that the corresponding private key owned and held in the passport by the agent. Must have the ability to be successfully confirm its validity, matching the client stored public key.

Web Token Architectonic Blocks.

Galois Counter Module (GCM), galois Linear Feedback Shift Register (gLFSR), or other Counter (CTR) modes. Use: to maintain message validity during “ping-pong,” of agent-to-client, incoming/outgoing message transfer. Without sending the concurrent counterstate module with every request. The counter module is used to derive the initialization vector (IV) at encryption/decryption time for the next state. Minimum Requirement: The produced counter sequence must be guaranteed not to repeat within a definable polynomial, or galois field.

Symmetric Encryption Key (SEK). Use: to encrypt/decrypt the incoming/outgoing messages, decryptable only by the intended target. Minimum Requirement: Target key entropy equal to or greater than 256-bits, minimum key entropy of 128-bits.

Hashed Message Authentication Code (HMAC). Use: to simultaneously verify both the data integrity and the authentication of a message. Minimum Requirement: Accurately, provable verification that no attacker tampered with the message before processing.

Cryptographic Signature (CS). Use: non-repudiation of the agent, absolute corresponding key verification. Minimum Requirement: Signature has to be: authentic, unfalsifiable, non-reusable, unalterable, and irrevocable.

Transaction Hash or User_ID (Id). Use: Agent database record location. Minimum Requirement: Attached to Provider provisioned immutable database. Available to the public providing access for record verification, and account recovery.

The selection of a data serialization format (Ex. protobuf(proto3)), most the [EX.15] data serialization formats may be used. Target formats compile to binary, are standardized or well known, and support zero-copy operations. Additionally, protobuf provides for the automatic generation of assigned field numbers which at have the ability to act as an additional in-flight attack tampering metric. If the message is altered or mirrored back to the server in hopes of a new or unique return stats. The resulting decrypted message will not fit the predefined message definition deserialization resulting in a broken process. Recovery and protection operations are available once message state is broken; executing predefined or individual prompted actions defined by the Provider deployed specification can begin taking system or user defined protective actions: (1) reset session connection, re-authenticate the agent, (2) send a warning message to the session owner, then reset session connection, (3) quarantine connection for further inspection, then reset or block connection, (4) blacklist and block connection.

Additional protective measures may be conducted to verify a secure connection, secure transit pipeline, and to verify the authenticity of the agent requesting authentication with a connection in question (added to quarantine, inspection, or blacklisted connection pools) . Client specific risk tagging rules and naming conventions can be generated during the Providers client specific system deployment.

The selection of the symmetric algorithm must be given selection. The goal of the symmetric encryption algorithm is to protect messages in transit, and may act as the last line of defense. There are three main type of symmetric encryption algorithms that incorporate a MAC to verify authenticity of the data in transit.

MtE (MAC then Encrypt), for example, calculates a MAC over plaintext, appended a MAC identifier to the plaintext package. Encrypt and send.

EtM (Encrypt then MAC)=SAFE, for example, encrypts the plaintext packet/contents calculates the MAC over the ciphertext and appends it.

EaM (Encrypt and MAC), for example, calculates the MAC over the plaintext, encrypted it and then appended the MAC.

As message validity must be confirmed before the message is decrypted. The only “safe,” method of process to use is EtM (Encrypt then Mac) as it would be necessary to decrypt, and process; MtE, or EaM packages before checking the message authentication code. Using MtE or EaM allows an active attacker the chance to view the protected functions of the encryption process before the MAC verifies the packet and detects mischief. The secondary protective measure that must take place before message or response is to obscure the message length. A secondary stream cipher instance may be used to encrypt packet lengths, or a message standardized block size may be used. In order to use a standardized block size, an overflow process must be set. A standard block size could theoretically be set to any bit/byte size; depending on the client or transmission acceptance rates.

EX Terms: AEAD->authenticated encryption and associated data. EtM->encrypt then MAC. Sig/SIG->cryptographic signature. Key->symmetric encryption key. Pubk->public Key. EtS->encrypt then sign.

See FIG. 14 illustrating an exemplary Token Serialization 1 1400, which may be relied upon in embodiments disclosed herein.

See FIG. 15 illustrating an exemplary Token Serialization 2 1500, which may be relied upon in embodiments disclosed herein.

FIG. 14 and FIG. 15 illustrate just two of many examples of how the tokens may be compiled. The main requirements for token serialization are: End-to-end encrypted, Minimum 256-bits for a secure randomly generated keys, “Safe [EN.16] ,” elliptic curves used, MAC/SIG must be verified before processing or decryption takes place, Standardized timeboxing for all encryption/decryption functions enforced, In-transit message size standardized, hidden, or duel cypher used.

Service Registration. New application registration historically involves setting up a username/password combo. This requires the user the generate or enter this information. The Key Authorization protocol can be set to automatically register based on agent interaction for a target system. For example, an agent navigates to an ecommerce application and would like to “checkout as guest.” The client has the opportunity to automatically generate a registration for the “guest,” creating a durable identity for future use and verification. Registration can also be specified to only commence once the agent has completed a specific interaction with the site.

Example: Agent clicks the “sign-up,” button. The agent has the additional option to approve the client to access specific information or data fields to be standardized.

Example: Agent clicks, “sign-up,” button; the passport pops-up and asks the user: (is it okay to send {CA:domain.com} your {email_address} to complete your account setup?) (y/n), which would be considered a Registration+transaction; as each interaction can be uniquely tailored during a request for information. RRFI (registration+request for information)

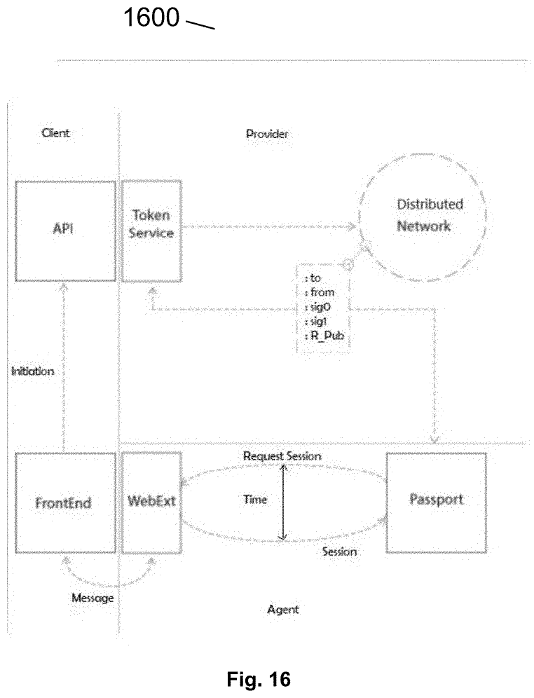

The registration process assumes that the agent has already setup a functioning Passport. As the web-ext may act as a Passport or a method to pass messages about. See FIG. 16 for an exemplary detailed showing of the passport separately to help define messages/processes being transacted, which may be relied upon in embodiments disclosed herein.

Initial Assumptions: Public-Main, Public-Recovery, and Private-Main keys ready.

Once the desired agent interaction (signup, autofire, checkout-as-guest) has occurred. The agent's passport will send the client the key package (Public-Main, Public-Recovery). Both the main, and recovery key are and should be saved via a durable medium before passing the main key to the token service.

The token service will then generate a proper network address based on the desired target network. The example above uses a distributed consensus-based network. Once the network address has been verified for authenticity, and validity. An immutable record is created recording: 1) Agents network address+cryptographic signature. 2) Clients network address+cryptographic signature. 3) Unique transaction identifier (TxID or TxHash). 4) (optional) Time of execution. 5) (optional) Agents recovery key. 6) (optional) Agents secondary recovery key. 7) (optional) Agents secondary verification key.

The immutable record is/can be used for agent Passport account recovery, client record database auditing, or as a fully distributed authentication database. The registration process is technically complete once the client has submitted, created, and verified the immutable recordset for correctness and authenticity.

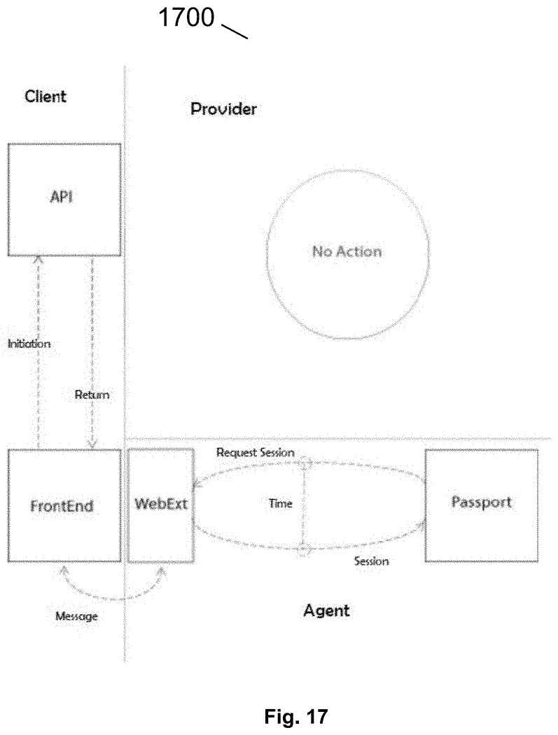

See FIG. 17 for an exemplary diagram illustrating Authentication & Authorization methods 1700, which may be relied upon in embodiments disclosed herein.

The Passport is an application users download that can run both natively on the user's device or in the user's browser via a web extension. The Passport allows the user to store his or her tokens as described herein created for the applications with which the user has account(s).

Users do not create usernames or individual application passwords, only a single passport passphrase. The password acts as the encryption key. On creation of a new user, he or she is assigned a private/public key pair for any access token that has been given for authenticating to services or applications. The password is then used to encrypt and decrypt the passport.

Form data secure storage and request model. Credit Cards secure storage/request model. Authentication/authorization (pub/pvt keys). Network identification (wifi sign-up). Ticketing system (movies, concerts, service). Distributed version control (signed downloads verification system). iOT automated access controls (device to device secure communication). 3rd party verified audit system (specified data viewing model). P2p communication platform (asymmetric encryption communication model). Service registration provider (directory management system). Localized p2p social media connection (individual p2p network node for peer-sharing). SSH or secure tunneling hub (terminal controlled key rotation system). Secure email service (like pgp email; only completed/integrated by default). VPN communication endpoint (sets up a new VPN registered connection upon network connection). untraceable VPN (connects to peer-verified (friends) passports for a multiple jump VPN scatter filter). Trust or recovery network (not just passport recovery; data recovery. Nudey photos can be protected using steganography cryptology then split or spread between a minimum number of peer-verified (verified friends) passports).—Family data warehousing—for example, families may register as “peers,” and setup a larger data vault using a multi-signature system to protect elderly family members in case of memory loss or tragedy, to ensure the right people have ALL of the right data. Project Arq (holacratic application sharing station, where every application must adhere to the same rule set during submission to the network). Professional Certificates—for example, when professional engineers are tested and have a certain number of years under their belt, they have the opportunity to gain the PE or professional engineer stamp, a passport could use one of the key addresses as a “professional,” verified stamp. Localized consus network—for example, where devices work together to secure themselves, every device contains a “vaccine,” or a root verification hash; at any point if a device's root verification hash doesn't match other devices in the network, and a material change hasn't been verified, the device in question is reset to a previous state. Supply chain or checkpoint verification: using the HD-key system; individual verification keys can be distributed and once the device/software needs to be stage verified, the individual key in that step may take place, creating a successful Trie structure, where if all stages were completed successfully then the root Trie hashes should match; if not, the non-matching hash at (x)step is where an error/attack occurred. Anonymous account registration and access. Others use cases are contemplated herein.

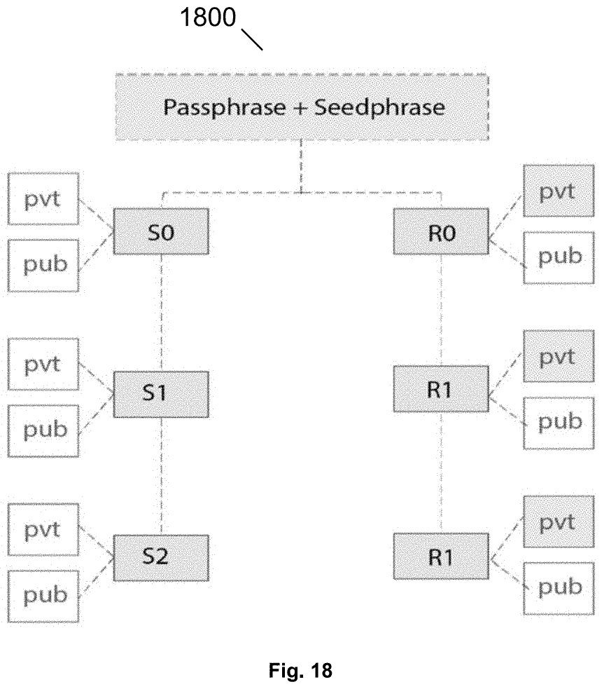

See FIG. 18 illustrating an exemplary diagram of a passphrase+seedphrase 1800, which may be relied upon in embodiments disclosed herein.

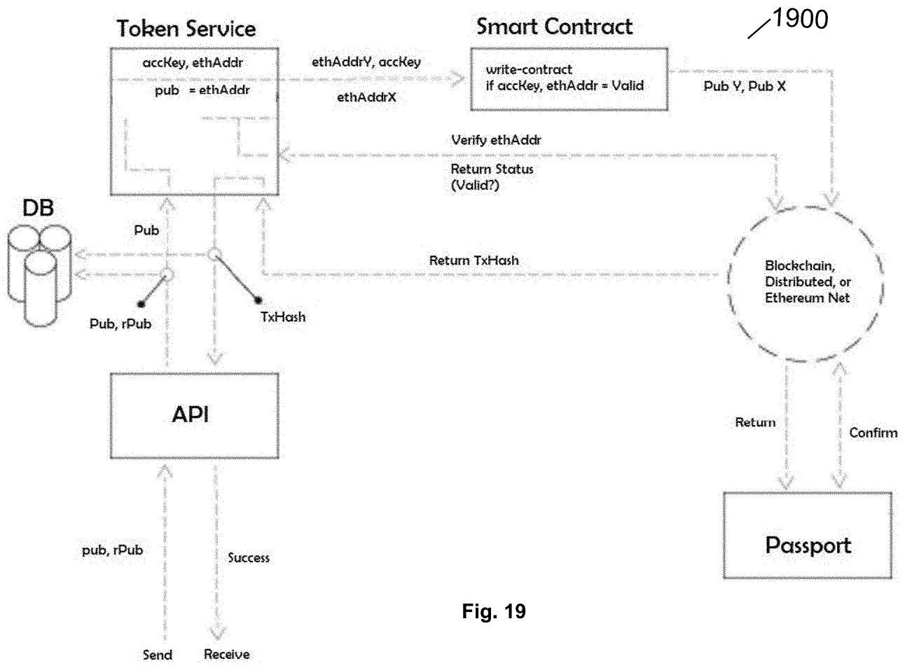

See FIG. 19 illustrating an exemplary Token Service with Recovery and Database Architecture 1900, which may be relied upon in embodiments disclosed herein. In some embodiments, for example, an Application Programming Interface or API may communicate with or provide a Token Service as described herein to authenticate or verify the identity of a user of a Passport App.

Use Case(s): Passport record recovery. Record recovery. Distributed immutable database. Message staging or p2p communication processing. Holacratic top-level registry. Localized network authentication token distribution system. P2P verified peers list (list of your friends and their contact addresses). p2p Temp data cache. Private encrypted data store. Certificate manager. Immutable data storage. ETL pre-staging data warehousing authenticity verification (think region to region backup or transit store) where a verification data signature can be verified or exchanged, transformed, and loaded into a new housing medium. 3rd party Identification housing (create recovery token->tied to personal data for KYC/AML verified identity creation). Systems processes or staged verification over non-standard time. Database record verification/data diff source check. LTKH or long-term key housing (if a 3rd party auditor needed an associated public key, they could be historically stored here for backup and records bullshit). User/agent endpoint stubbing (creating a durable messaging endpoint that could be connected with a systematically or periodically updated communication infrastructure). I.E. static-IP->VPN(daily changing keys/addresses), for long-term communication verified peers would store the durable “static,” endpoint. Other use cases are contemplated herein.

PreCryption Network Encryption Protocol. PreCryption is a defined network protocol used as a one-time data encryption process. This can be used the ensure the validity of form based data. The simple process can be used to prevent agent information from being breached by form based attacks, where the provided agent information has value. (credit-card, social security number, address, phone number, ect) This process does not protect agents from possible keylogger attacks as keystrokes are not protected. A virtualized keyboard may be used to subvert possible keylogger attacks.

Protocol Design. Once an agent (user) navigates to the target form; an additional hidden value is transmitted to the agent's system. The hidden value is a public facing asymmetric encryption key. This key can be statically added to the form. If a static public key is used, the static key must have a defined expiration date. If a dynamic public key is sent or a key for that individual form session is transmitted. Additional verification steps must be taken as, the agent would be unable to verify that the correct key was sent. If an attacker is able to “replay,” the transmitted public key with one of his or her choosing. Then the encrypted form may only be decrypted by the attacker. Thus key verification is critical before form transmission or vital, personal information may be leaked to an attacker.

Once the correct key has been verified then the individual form values may be targeted, in order to mask individual plaintext field lengths. Each form field value is given a maximum character length, with the maximum length carefully selected based on historic user interaction. Each field's maximum character capacity will be utilized creating indistinguishable encrypted form length, masking an attacker's opportunity to find field or value size. This also generates a standard total form size, which may be used as the initial client-side verification. If the form doesn't match (x)size, then this indicates someone has been tampering with the bits. The form encryption process should be timeboxed or completed based on a standard timing target. The resulting encrypted ciphertext will have a message authenticity code (MAC) attached. Once the ciphertext is serialized (JSON, XML, ect) the form is ready for transit. The encryption process MUST be EtM (Encrypt then MAC) process based. If EtM is not used, the client could leak potential encryption parameter information. As the message authenticity must be verified before decryption or processing.

If the transmitted public key is a “one-time,” use key. Then once the encrypted form data is received, and the MAC has been verified. Individual fields are decrypted and verified. Once the decryption/processing has been completed the key pair used is to zero'd or having the memory space overwritten to have ‘0x0’ values added to each byte/bit.

Use Cases: Anywhere structured data fields are used to request information to achieve a desired output in a secure manner. However, PreCryption should not be used as a primary line of defense. Its primary use should be as additional data in-flight protection or protective measure.

The following publications are incorporated herein by reference for all proper purposes: The Complexity of Theorem-proving Procedures. STOC '71: Proceedings of the third annual ACM symposium on Theory of computing, published May 1971, Pages 151-158, Link: https://doi.org/10.1145/800157.805047. A survey of Man in the Middle Attacks, STOC '71: Proceedings of the third annual ACM symposium on Theory of computing, May 1971 Pages 151-158, Link: https://doi.org/10.1145/800157.805047. RFC-7435 Opportunistic Security: Some Protection Most of the Time. Link: https://www.rfc-editor.org/info/rfc7435. Published at least as early as Jan. 22, 2019. Stuxnet: Dissecting a Cyberwarfare Weapon. Link: https://ieeexplore.ieee.org/abstract/document/5772960. Published at least as early as Jan. 22, 2019. A taxonomy of replay attacks [cryptographic protocols]. Link: https://ieeexplore.ieee.org/abstract/document/315935. Published at least as early as Jan. 22, 2019. Xml external entity attacks (xxe). Link: http://repository.root-me.org/Exploitation%20-%20Web/EN%20-%20XML%20External%20Entity%20Attacks%20(XXE)%20-%20owasp.pdf. Published at least as early as Jan. 22, 2019. The evolution of cross site scripting attacks. Link: https://www.cgisecurity.com/lib/xss.pdf. Published at least as early as Jan. 22, 2019. A novel method for SQL injection attack detection. Link: https://www.sciencedirect.com/science/article/pii/S0895717711000689. Published at least as early as Jan. 22, 2019. Botnet: Classification, Attacks, Detection, Tracing, and Preventive Measures. Link: https://link.springer.com/article/10.1155/2009/692654. Published at least as early as Jan. 22, 2019. Preventing phishing attacks. Link: https://patents.google.com/patent/US7681234B2/en. Published at least as early as Jan. 22, 2019. A billion keys, but few locks: the crisis of web single sign-on. Link: https://dl.acm.org/citation.cfm?id=1900556. Published at least as early as Jan. 22, 2019. Cyber security risks in the supply chain. Link: https://www.ncsc.gov.uk/content/files/protected_files/guidance_files/Cyber-security-risks-in-the-supply-chain.pdf. Published at least as early as Jan. 22, 2019. InterPlanetary File System. Link: https://github.com/ipfs/papers/raw/mastedipfs-cap2pfs/ipfs-p2p-file-system.pdf. Published at least as early as Jan. 22, 2019. Database Fields. Link: https://www.progenygenetics.com/knowledgebase/index.php?/Knowledgebase/Article/View/21/0/database-field-types-and-database-fields. Published at least as early as Jan. 22, 2019. Comparison of data serialization formats (non-academic, rough formats list). Link: https://en.wikipedia.org/wiki/Comparison_of_data_serialization_formats. Published at least as early as Jan. 22, 2019. Safe curves for elliptic-curve cryptography. Link: https://safecurves.cr.yp.to/. Published at least as early as Jan. 22, 2019.

2FA, 3FA, and other Multi-factor authentication processes are contemplated herein.

Various browser communication methods are contemplated herein. A blockchain-based distributed computing platform and operating system featuring smart contract functionality may be referenced herein as an etherium network, distributed network, or blockchain network. Token Service for use in non-block networks is contemplated herein. Token service without blocking other non-blockchain based networks is contemplated herein. Passport without network blockers is contemplated herein. Global communication params are contemplated herein.

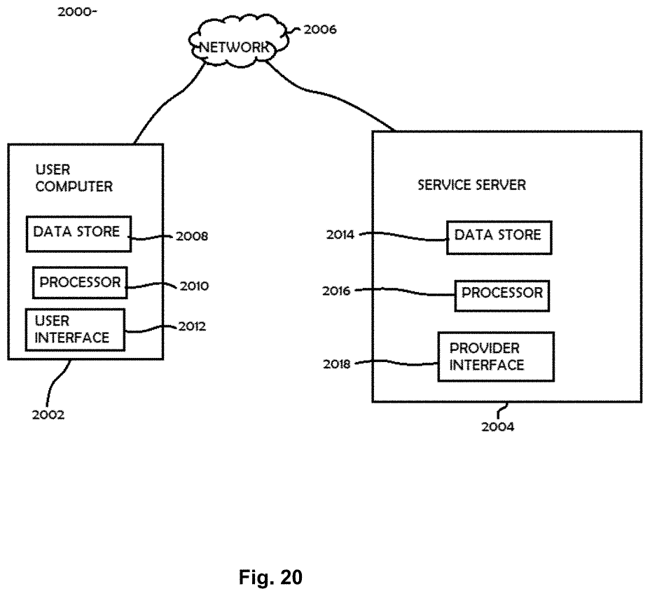

Turning now to FIG. 20, an exemplary system 2000 is now described. The system 2000 may include a user computer 2002 having a user interface 2012, a data store 2008, and a processor 2010. The processor 2010 may include a tangible, computer-readable medium having instructions which, when executed, carry out one of the methods described below. The system 2000 may include an service server 2004 having a network communication 2006 with the user computer 2002. The server 2004 may include a data store 2014, a provider interface 2018, and a processor 2016. The processor 2016 may include a tangible, computer-readable medium having instructions which, when executed, carry out one of the methods described below. As an example, the user computer 2002 may be configured to carry out the method 2100 and the server 2004 may be configured to carry out he method 2200. As another example, the user computer 2002 may be configured to carry out the method 2300 and the server 2004 may be configured to carry out he method 2400, whereby data may be securely transmitted.

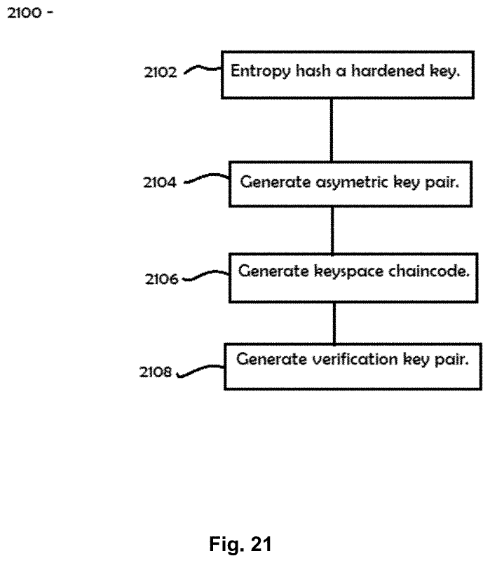

Turning now to FIG. 21, an exemplary method 2100 is now described. The method 2100 may include entropy hashing a hardened key 2102 and generating an asymmetric key pair from the hardened key 2104. The method 2100 may include generating a keyspace chaincode from the hardened asymmetric key pair and the hardened key 2106 and generating a verification key pair from the hardened asymmetric key pair 2108.

In some embodiments of the method 2100, generating an asymmetric key pair 2104 includes passing a random value to an elliptic curve. In some embodiments, the elliptic curve is a safe elliptic curve. In some embodiments of the method 2100, entropy hashing a hardened key 2102 includes entropy hashing a hardened seed key and a hardened recovery key. The method 2100 may include a method of authenticating or verifying the identity of a user or encrypting data.

The method 2100 may include the protocols or rely on the teachings illustrated in FIGS. 1-20.

Embodiments herein may include a tangible, computer-readable medium comprising instructions which, when executed, carry out the method 2100. The medium may be non-transitory in nature. The medium may be distributed across a plurality of media.

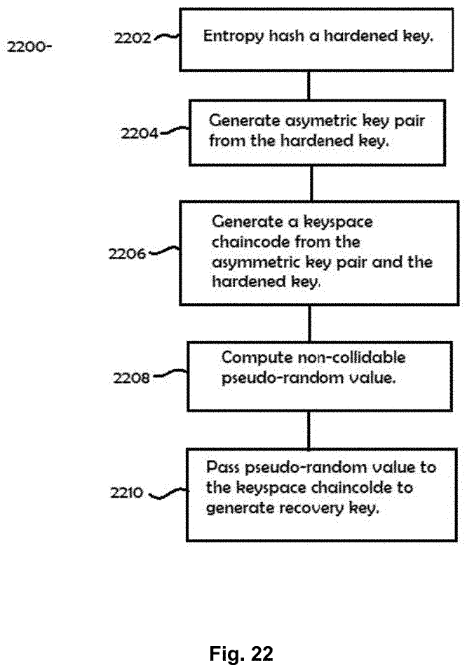

Turning now to FIG. 22, a method 2200 of generating a recovery key is described. The method 2200 may include entropy hashing a hardened key 2202 and generating an asymmetric key pair from the hardened key 2204. The method 2200 may include generating a keyspace chaincode from the hardened asymmetric key pair and the hardened key 2206. The method 2200 may include computing a non-collidable pseudo-random value 2208 and passing the pseudo-random value to the keyspace chaincode to generate the recovery key 2210. The method 2200 may include the protocols or rely on the teachings illustrated in FIGS. 1-21.

Embodiments herein may include a tangible, computer-readable medium comprising instructions which, when executed, carry out the method 2200. The medium may be non-transitory in nature and may be distributed across a plurality of media.

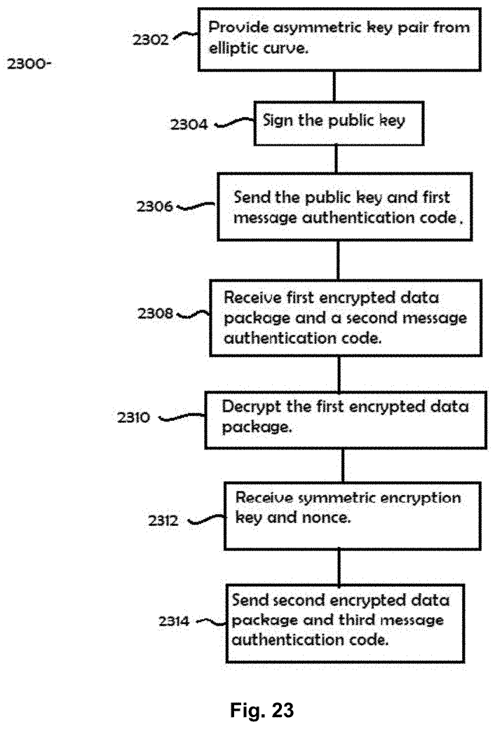

Turning now to FIG. 23, an exemplary method 2300 is disclosed. The method 2300 may include providing 2302 an asymmetric key pair having a public key and a private key from an elliptic curve, signing 2304 the public key with a first message authentication code, and sending 2306 the public key and the first message authentication code to another party. The method 2300 may include receiving 2308 a first encrypted data package and a second message authentication code from the another party. The method 2300 may include decrypting 2310 the first encrypted data package using the private key. The method 2300 may include receiving 2312 a symmetric encryption key and a nonce from the another party. The method 2300 may include sending 2314 a second encrypted data package and a third message authentication code to the another party, wherein the second encrypted data package comprises a public identifier.

In some embodiments of the method 2300, the second encrypted data package is generated using a second state of the nonce and the symmetric encryption key. The method 2300 may include assigning a state to the nonce. The method 2300 may include a method of authenticating or verifying the identity of a user or encrypting data. The method 2300 may include the protocols or rely on the teachings illustrated in FIGS. 1-22.

Embodiments herein may include a tangible, computer-readable medium comprising instructions which, when executed, carry out the method 2300. The medium may be non-transitory in nature. The medium may be distributed across a plurality of media.

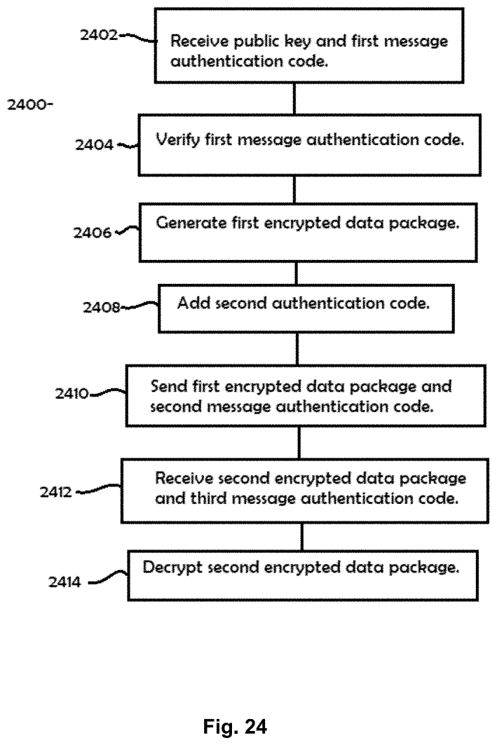

Turning now to FIG. 24, an exemplary method 2400 is now described. The method 2400 may include receiving 2402 a public key and a first message authentication code from another party, and verifying 2404 the first message authentication code. The method 2400 may include, using the public key, generating 2406 a first encrypted data package having a symmetric encryption key and a first nonce state. The method 2400 may include adding 2408 a second message authentication code to the first encrypted data package, and sending 2410 the first encrypted data package and the second message authentication code to the another party. The method 2400 may include receiving 2412 a second encrypted data package and a third message authentication code from the another party, wherein the second encrypted data package comprises a public identifier. The method 2400 may include, using a second nonce state and the symmetric encryption key, decrypting 2414 the second encrypted data package. The method 2400 may include a method of authenticating or verifying the identity of a user or encrypting data. The method 2400 may include the protocols or rely on the teachings illustrated in FIGS. 1-23.

Embodiments herein may include a tangible, computer-readable medium comprising instructions which, when executed, carry out the method 2400. The medium may be non-transitory in nature and may be distributed across a plurality of media.

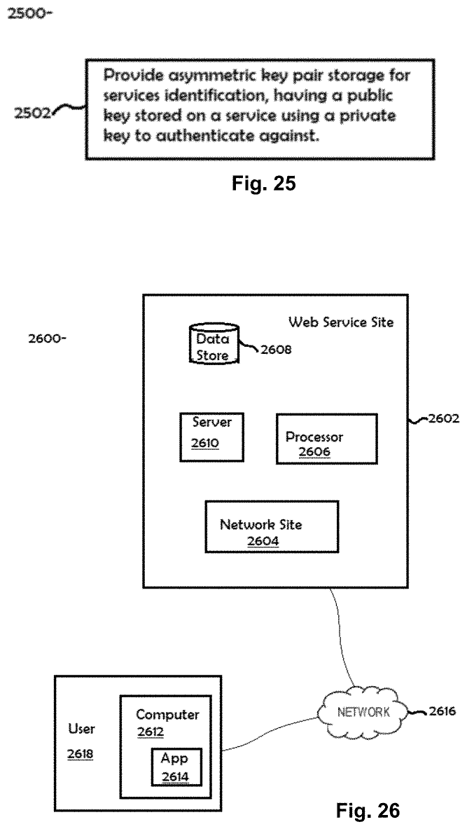

FIG. 25 illustrates a method 2500 of services identification. The method 2500 includes providing 2502 asymmetric key pair storage for services identification, having a public key stored on a service using a private key to authenticate against. The method 2500 may include a method of authenticating or verifying the identity of a user or encrypting data. The method 2500 may include the protocols or rely on the teachings illustrated in FIGS. 1-24.

Embodiments herein may include a tangible, computer-readable medium comprising instructions which, when executed, carry out the method 2500. The medium may be non-transitory in nature and may be distributed across a plurality of media.

Turning now to FIG. 26, a system 2600 for providing a web-based service to a user 2618 is described. The system 2600 may include a web service site 2602 having a network site 2604 and a server 2610 for supporting the services. The site 2602 may have or communicate with a processor 2606 such as a tangible, computer-readable medium. The site 2602 may include a data store 2608 having a public key stored thereon. The user 2618, operating a computer 2612 means, may generate a private key using an app 2614, which may be substantially as described in relation to the passport described herein, stored on the computer 2612. The private key may be communicated to the site 2602 via any network means 2616 in the art. The processor 2606 may authenticate the public key from the data store 2608 against the private key from the app 2614. The system 2600 may provide a web-based service including an asymmetric key pair storage for services identification, having a public key stored on the service and using a private key to authenticate against. The system 2600 may execute the protocols or rely on the teachings illustrated in FIGS. 1-25.

Embodiments herein may include a tangible, computer-readable medium comprising instructions which, when executed, carry out a method. The medium may be non-transitory in nature. The method may include a method of authenticating or verifying the identity of a user or encrypting data.

A first method may include: (1) entropy hashing a hardened key; (2) generating an asymmetric key pair from the hardened key; (3) generating a keyspace chaincode from the hardened asymmetric key pair and the hardened key; and (4) generating a verification key pair from the hardened asymmetric key pair. The method may also include, wherein generating an asymmetric key pair comprises (5) passing a random value to an elliptic curve. The the elliptic curve may be a safe elliptic curve. In some embodiments, entropy hashing a hardened key includes entropy hashing a hardened seed key and a hardened recovery key.

A second method may include a method of generating a recovery key. The second method may include (1) entropy hashing a hardened key; (2) generating an asymmetric key pair from the hardened key; (3) generating a keyspace chaincode from the hardened asymmetric key pair and the hardened key; (4) computing a non-collidable pseudo-random value; and (5) passing the pseudo-random value to the keyspace chaincode to generate the recovery key.

The first method and the second method may be executed by the computer-readable medium. The first method and the second method may be executed substantially simultaneously or substantially concurrently.

A third method may include (1) providing an asymmetric key pair having a public key and a private key from an elliptic curve; (2) signing the public key with a first message authentication code; (3) sending the public key and the first message authentication code to another party; (4) receiving a first encrypted data package and a second message authentication code from the another party; (5) using the private key, decrypting the first encrypted data package; (6) receiving a symmetric encryption key and a nonce from the another party; (7) sending a second encrypted data package and a third message authentication code to the another party, wherein the second encrypted data package comprises a public identifier. The third method may include, wherein the second encrypted data package is generated using a second state of the nonce and the symmetric encryption key. The third method may include assigning a state to the nonce.

A fourth method may include (1) receiving a public key and a first message authentication code from another party; (2) verifying the first message authentication code; (3) using the public key, generating a first encrypted data package having a symmetric encryption key and a first nonce state; (4) adding a second message authentication code to the first encrypted data package; (5) sending the first encrypted data package and the second message authentication code to the another party; (6) receiving a second encrypted data package and a third message authentication code from the another party, wherein the second encrypted data package comprises a public identifier; and (7) using a second nonce state and the symmetric encryption key, decrypting the second encrypted data package.

Embodiments herein may include a first tangible, computer-readable medium comprising instructions which, when executed, carry out the third method, and a second tangible, computer-readable medium comprising instructions which, when executed, carry out the fourth method.

In some embodiments, a method of services identification is provided. The method may include providing asymmetric key pair storage for services identification, having a public key stored on a service using a private key to authenticate against. The method may include other actions or features otherwise described herein.

In some embodiments, a web-based service is provided. The service may include an asymmetric key pair storage for services identification having a public key stored on the service and using a private key to authenticate against. The service may include other features or may be derived from actions otherwise described herein.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “fastener” should be understood to encompass disclosure of the act of “fastening”—whether explicitly discussed or not—and, conversely, were there only disclosure of the act of “fastening”, such a disclosure should be understood to encompass disclosure of a “fastening mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only.

Similarly, the claim shall also read on a device that requires “A+B”. The claim shall also read on a device that requires “A+B+C”, and so forth.

The claims shall also be construed such that any relational language (e.g. perpendicular, straight, parallel, flat, etc.) is understood to include the recitation “within a reasonable manufacturing tolerance at the time the device is manufactured or at the time of the invention, whichever manufacturing tolerance is greater”.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

What is claimed is:

1. A method, comprising:
entropy hashing a hardened key;
generating an asymmetric key pair from the hardened key;
generating a keyspace chaincode from the hardened asymmetric key pair and the hardened key; and
generating a verification key pair from the hardened asymmetric key pair.

2. The method of claim 1, wherein:
generating an asymmetric key pair comprises:
passing a random value to an elliptic curve.

3. The method of claim 2, wherein:
the elliptic curve is a safe elliptic curve.

4. The method of any preceding claim, wherein:
entropy hashing a hardened key comprises entropy hashing a hardened seed key and a hardened recovery key.

5. A tangible, computer-readable medium comprising instructions which, when executed, carry out a method, the method comprising:
entropy hashing a hardened key;
generating an asymmetric key pair from the hardened key;
generating a keyspace chaincode from the hardened asymmetric key pair and the hardened key; and
generating a verification key pair from the hardened asymmetric key pair.

6. The medium of claim 5, wherein:
generating an asymmetric key pair comprises:
passing a random value to an elliptic curve.

7. The medium of claim 6, wherein:
the elliptic curve is a safe elliptic curve.

8. The medium of any one of claims 5 through 7, wherein:
entropy hashing a hardened key comprises entropy hashing a hardened seed key and a hardened recovery key.

9. A method of generating a recovery key, comprising:
entropy hashing a hardened key;
generating an asymmetric key pair from the hardened key;
generating a keyspace chaincode from the hardened asymmetric key pair and the hardened key;
computing a non-collidable pseudo-random value; and
passing the pseudo-random value to the keyspace chaincode to generate the recovery key.

10. A tangible, computer-readable medium comprising instructions which, when executed, carry out a method of generating a recovery key, the method comprising:
entropy hashing a hardened key;
generating an asymmetric key pair from the hardened key;
generating a keyspace chaincode from the hardened asymmetric key pair and the hardened key;
computing a non-collidable pseudo-random value; and
passing the pseudo-random value to the keyspace chaincode to generate the recovery key.

11. A method, comprising:
providing an asymmetric key pair having a public key and a private key from an elliptic curve;
signing the public key with a first message authentication code;
sending the public key and the first message authentication code to another party;
receiving a first encrypted data package and a second message authentication code from the another party;
using the private key, decrypting the first encrypted data package;
receiving a symmetric encryption key and a nonce from the another party;
sending a second encrypted data package and a third message authentication code to the another party, wherein the second encrypted data package comprises a public identifier.

12. The method of claim 11, wherein:
the second encrypted data package is generated using a second state of the nonce and the symmetric encryption key.

13. The method of claim 11 or claim 12, further comprising:
assigning a state to the nonce.

14. A tangible, computer-readable medium comprising instructions which, when executed, carry out a method, the method comprising:
providing an asymmetric key pair having a public key and a private key from an elliptic curve;
signing the public key with a first message authentication code;
sending the public key and the first message authentication code to another party;
receiving a first encrypted data package and a second message authentication code from the another party;
using the private key, decrypting the first encrypted data package;
receiving a symmetric encryption key and a nonce from the another party;
sending a second encrypted data package and a third message authentication code to the another party, wherein the second encrypted data package comprises a public identifier.

15. The medium of claim 14, wherein:
the second encrypted data package is generated using a second state of the nonce and the symmetric encryption key.

16. The medium of claim 14 or claim 15, further comprising:
assigning a state to the nonce.

17. A method, comprising:
receiving a public key and a first message authentication code from another party;
verifying the first message authentication code;
using the public key, generating a first encrypted data package having a symmetric encryption key and a first nonce state;
adding a second message authentication code to the first encrypted data package;
sending the first encrypted data package and the second message authentication code to the another party;
receiving a second encrypted data package and a third message authentication code from the another party, wherein the second encrypted data package comprises a public identifier;
using a second nonce state and the symmetric encryption key, decrypting the second encrypted data package.

18. A tangible, computer-readable medium comprising instructions which, when executed, carry out a method, the method comprising:
receiving a public key and a first message authentication code from another party;
verifying the first message authentication code;
using the public key, generating a first encrypted data package having a symmetric encryption key and a first nonce state;
adding a second message authentication code to the first encrypted data package;
sending the first encrypted data package and the second message authentication code to the another party;
receiving a second encrypted data package and a third message authentication code from the another party, wherein the second encrypted data package comprises a public identifier;
using a second nonce state and the symmetric encryption key, decrypting the second encrypted data package.

19. A method of services identification, comprising:
providing asymmetric key pair storage for services identification, having a public key stored on a service using a private key to authenticate against.

20. A tangible, computer-readable medium comprising instructions which, when executed, carry out a method of services identification, the method comprising:
providing asymmetric key pair storage for services identification, having a public key stored on a service using a private key to authenticate against.

21. A web-based service, comprising:
an asymmetric key pair storage for services identification, having a public key stored on the service and using a private key to authenticate against.

22. A tangible, computer-readable medium comprising instructions which, when executed, carry out a method of web-based service, comprising:
providing an asymmetric key pair storage for services identification, having a public key stored on the service and using a private key to authenticate against.
